(19) United States
(12) Patent Application Publication
(10) Pub. No.: US 2016/0337718 A1
(43) Pub. Date: Nov. 17, 2016

(54) AUTOMATED VIDEO PRODUCTION FROM A PLURALITY OF ELECTRONIC DEVICES

(71) Applicant: Joshua Allen Talbott, Akron, OH (US)

(72) Inventor: Joshua Allen Talbott, Akron, OH (US)

(21) Appl. No.: 15/183,241

(22) Filed: Jun. 15, 2016

Related U.S. Application Data
(60) Provisional application No. 62/183,376, filed on Jun. 23, 2015.
(60) Provisional application No. 62/054,129, filed on Sep. 23, 2014.

(51) Int. Cl. H04N 21/8547; H04N 21/234; H04N 21/43; H04N 21/242; H04N 21/4223; H04N 21/45; H04N 5/77; H04N 21/218

(52) U.S. Cl. CPC H04N 21/8547; H04N 5/772; H04N 21/23424; H04N 21/21805; H04N 21/242; H04N 21/4223; H04N 21/4524; H04N 21/4307

(57) ABSTRACT

A computer implemented and electronic device for to capture and process video and environmental information while using the mobile device in a conventional manner to capture and store video of an event. The information associated with the video is specifically designed to allow videos taken of the same scene, at the same time, from a plurality of users to be automatically combined for a seamless video production of the scene as the video transitions between different devices.

### CLAIM OF PRIORITY AND RELATED APPLICATIONS

This application is a non-provisional application of and claims the benefit of U.S. Provisional Application Ser. No. 62/183,376 filed on Jun. 23, 2015 and entitled “AUTOMATED VIDEO PRODUCTION FROM A PLURALITY OF ELECTRONIC DEVICES” and U.S. Provisional Application Ser. No. 62/054,129 filed on Sep. 23, 2014 and entitled “AUTOMATED VIDEO PRODUCTION FROM A PLURALITY OF ELECTRONIC DEVICES.” The entireties of the aforementioned applications are incorporated herein by reference.

### TECHNICAL FIELD

The present disclosure relates generally to videography and, more particularly, to a system and method that allows multiple videos taken from a plurality of electronic devices at the same event to be viewed by different viewers and the videos may be concatenated into a single video production.

### BACKGROUND

Mobile and/or wireless electronic devices are becoming increasingly popular. For example, mobile telephones, portable media players, and portable gaming devices are now in wide-spread use. In addition, the features associated with certain types of electronic devices have become increasingly diverse. For example, many mobile telephones now include cameras that are capable of capturing still images and video images. Some of these cameras are capable of taking relatively high quality images. Time and date information also may be stored with captured images so that the photograph or video may be retrieved based on when the photograph or video was taken.

Also, many electronic devices that include imaging devices also include location determining technology, such as global positioning system (GPS) positioning technology. Using location information that is determined at the time an image was captured allows the image to be “geotagged” with the location information. This allows the user to retrieve images based on where the photograph or video was taken.

It is common for multiple users at an event to generate different images of the same event based on the individual's location relative to the event. There remain significant challenges in combining the images or videos from a plurality of mobile devices capturing the same event from different vantages. There are also significant challenges with allowing a user to view or select the images or videos from other devices.

### SUMMARY

At every event, everyone everywhere is taking videos with smart phones. When these videos are played back they are almost always disappointing. Besides regular issues of poor lighting and shaking, only the smart phone's single point of view is available—a view that is mostly boring because it fails to capture the drama of what was videoed. One aspect of the invention is to take the best videos of everyone at the event and automatically weave them together to show the full story to everyone. This ensures that no one misses anything and everyone has the best version of what happened. It's the difference between looking through a keyhole and having the door thrown open.

One aspect of the invention is to provide a mechanism for users of electronic devices to capture and process video and environmental information while using the mobile device in a conventional manner to capture and store video of an event. The information associated with the video is specifically designed to allow videos taken of the same scene, at the same time, from a plurality of users to be automatically combined for a seamless video production of the scene as the video transitions between different devices. As such, the video playback, including both audio and video, will switch between different recordings from different users or electronic devices, while appearing to the user to be a seamless production having multiple viewpoints.

In one embodiment, the system and method provides a single video presentation from multi-video sources by automated production. The following describes the systems and process by which a user searches, discovers, or links to a query about a video event that generates a new video production, based on the online resources available (databases, video files, etc.).

One aspect of the invention relates to a computer-implemented method for producing a single concatenated video stream, the method including: receiving video data at a server from a plurality of electronic devices within a prescribed geographic area, wherein the video data includes image data and acquisition parameters associated with acquisition of each of the video streams, and the video data includes a time synchronization value to index the video data received by each of the plurality of electronic devices; and processing the received video data based on the synchronization offset and the acquisition parameters to generate a single concatenated video stream from the plurality of electronic devices.

Another aspect of the invention relates to an electronic device, including: a camera assembly, wherein the camera assembly is configured to record video images represented on an imaging sensor, the camera assembly further includes imaging optics associated with focusing of the camera assembly; a position data receiver configured to detect a geographical location of the electronic device; a memory configured to store the video images and information associated with the imaging optics and the position data receiver, the memory further configured to store an event sharing support function; and a processor configured to execute the event sharing support function, which causes the electronic device to request a time synchronization value from a remote server upon initiation of the camera assembly, wherein the processor is further configured to store the video images and the information in a synchronized manner based on the time synchronization value; and a communication interface for transmitting the video images and information to an associated server.

Another aspect of the invention relates to a method for displaying a single concatenated video stream generated from a plurality of devices on an electronic device, the method including: transmitting a request to a remote server for a single concatenated video stream generated from a plurality of devices within a prescribed geographical area; receiving the single concatenated video stream at the electronic device; and displaying the video stream on a display associated with the electronic device.

Another aspect of the invention relates to a computer-implemented method for selecting a video stream display captured by a plurality of disparate electronic devices, the method including: receiving a user-defined request from a server to generate a notification when a prescribed number of electronic devices within a geographical area are transmitting video to the server; receiving independent video streams at the server from electronic devices within the geographical area; determining, at the server, that a quantity of the received independent video streams are recording a common event; determining, at the server, if the quantity of the independent video streams are above the prescribed number of electronic devices; generating, at the server, a notification to one or more electronic devices; and receiving a request, at the server, from one or more of the electronic devices to transmit one or more portions of the independent video streams to the one or more electronic devices.

### BRIEF DESCRIPTION OF THE DRAWINGS

FIGS. 1 and 2 are respectively a front view and a rear view of an exemplary electronic device that includes a representative camera assembly;

FIG. 3 is a schematic block diagram of the exemplary electronic device of FIGS. 1 and 2;

FIG. 4 is a schematic diagram of a communications system in which the electronic device may operate;

FIG. 5 is a flow diagram of exemplary steps carried out by electronic devices in a representative system for producing a single concatenated video stream from a plurality of devices within a geographic area or at an event; and

FIG. 6 is another representative diagram of a communications system in which the electronic device may operate; and

FIG. 7 is an exemplary method for producing a single concatenated video stream from a plurality of devices.

FIG. 8 is an exemplary method for selecting a video stream display captured by a plurality of disparate electronic devices.

### DETAILED DESCRIPTION OF EMBODIMENTS

Embodiments will now be described with reference to the drawings, wherein like reference numerals are used to refer to like elements throughout. It will be understood that the figures are not necessarily to scale.

Described below in conjunction with the appended figures are various embodiments of an improved system and method for sharing video images from a plurality of users at an event. In the illustrated embodiments, imaging devices that form part of the system for sharing videos are embodied as digital camera assemblies that are made part of respective mobile telephones. It will be appreciated that aspects of the disclosed system and method may be applied to other operational contexts such as, but not limited to, the use of dedicated cameras or another type of electronic devices that include a camera (e.g., tablets, personal digital assistants (PDAs), media players, gaming devices, computers, etc.). The described camera assemblies may be used to capture image data in the form of still images, also referred to as pictures, photographs and photos, but it will be understood that the camera assemblies may be capable of capturing video images in addition to still images.

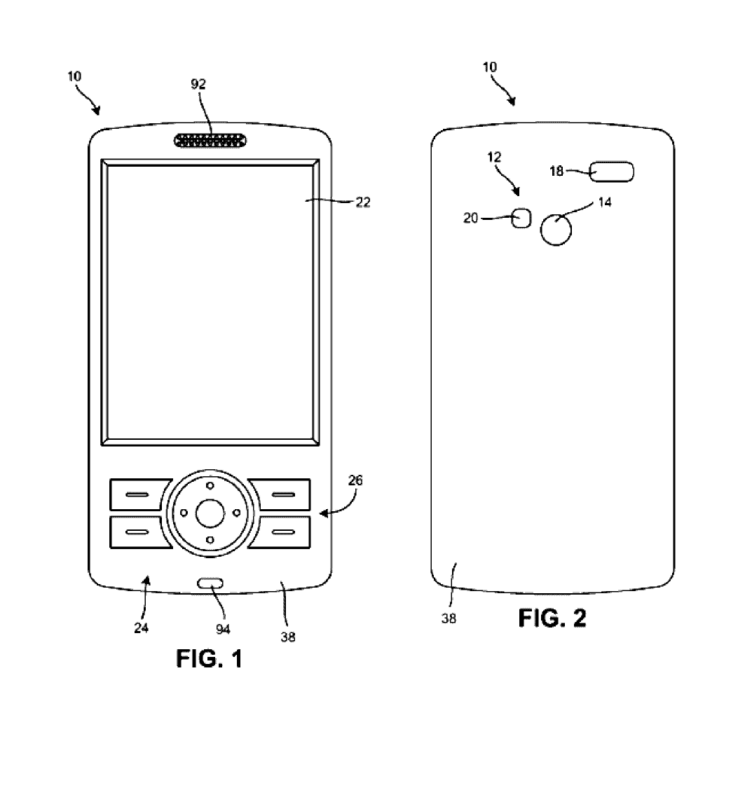

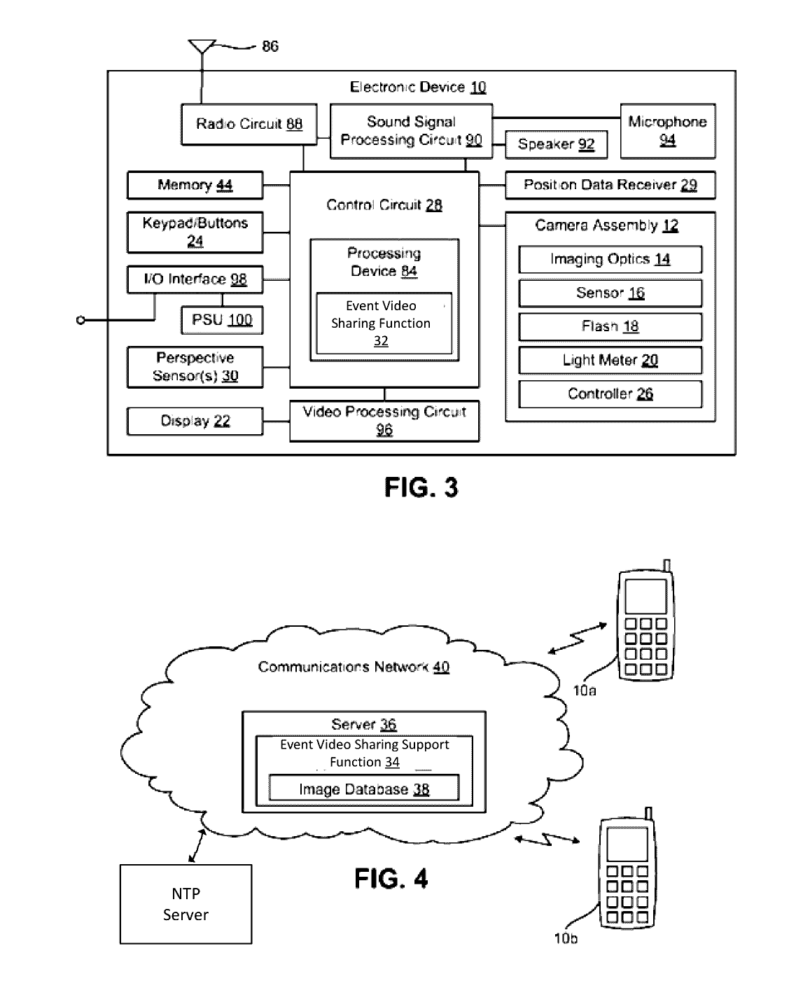

Referring initially to FIGS. 1 through 3, an electronic device 10 is shown. The illustrated electronic device 10 is a mobile telephone. A person of ordinary skill in the art will appreciate that a variety of electronic devices, e.g., computers, templates, cameras, etc., may be used in accordance with aspects of the present invention.

The electronic device 10 includes a camera assembly 12 for taking digital still images and/or digital video images. The camera assembly 12 may be arranged as a typical camera assembly that includes imaging optics 14 to focus light from a portion of a scene that is within the field-of-view of the camera assembly 12 onto a sensor 16. The sensor 16 converts the incident light into image data. The imaging optics 14 may include various optical components, such as a lens assembly and components that supplement the lens assembly (e.g., a protective window, a filter, a prism, and/or a mirror). The imaging optics 14 may be associated with focusing mechanics, focusing control electronics, optical zooming mechanics, zooming control electronics, etc. Other camera assembly 12 components may include a flash 18 to provide supplemental light during the capture of image data for a photograph, a light meter 20, a display 22 for functioning as an electronic viewfinder and as part of an interactive user interface, a keypad and/or buttons 24 for accepting user inputs, an optical viewfinder (not shown), and any other components commonly associated with cameras. One of the keys or buttons 24 may be a shutter key that the user may depress to command the taking of a photograph. The electronic device may include a user interface that is made up of one or more of the following components: display 22, keypad and/or buttons 24, speaker 92, and microphone 94.

Another component of the camera assembly 12 may be an electronic controller 26 that controls operation of the camera assembly 12. The controller 26 may be embodied, for example, as a processor that executes logical instructions that are stored by an associated memory, as firmware, as an arrangement of dedicated circuit components, or as a combination of these embodiments. Thus, methods of operating the camera assembly 12 may be physically embodied as executable code (e.g., software) that is stored on a machine readable medium and/or may be physically embodied as part of an electrical circuit. In another embodiment, the functions of the electronic controller 26 may be carried out by a control circuit 28 that is responsible for overall operation of the electronic device 10. In this case, the controller 26 may be omitted. In another embodiment, camera assembly 12 control functions may be distributed between the controller 26 and the control circuit 28.

It will be understood that the sensor 16 may generate output image data at a predetermined frame rate to generate a preview video signal that is supplied to the display 22 for operation as an electronic viewfinder. Typically, the display 22 is on an opposite side of the electronic device 10 from the imaging optics 14. In this manner, a user may point the camera assembly 12 in a desired direction and view a representation of the field-of-view of the camera assembly 12 on the display 22. As such, the camera assembly 12 may have a point-of-view, or perspective. The point-of-view is a combination of a location of the camera assembly 12 and a direction in which the camera assembly 12 is aimed by the user. The point-of-view of the camera assembly 12, in combination with characteristics of the imaging optics 14 and optical settings, such as an amount of zoom, establish the field-of-view of the camera assembly.

In one embodiment, the electronic device 10 includes one or more components that may be used to determine the point-of-view of the camera assembly 12 at a given moment in time, such as when the user commands the taking of a video or is composing a video while observing the viewfinder. For example, the electronic device 10 may include a position data receiver 29 for use in determining a location of the electronic device 10. The position data receive 28 may be, for example, a global positioning system (GPS) receiver, Galileo satellite system receiver or the like. The location data received by the position data receiver 29 may be processed to derive a location value, such as coordinates expressed using a standard reference system (e.g., the world geodetic system or WGS, assisted-GPS, or any other reference system). Location information may be determined in other manners. For instance, under global system mobile communications (GSM) and universal mobile telecommunications system (UMTS) protocols, the position could be estimated through a mobile originated location request (MO-LR) to the network so that the electronic device 10 position could be estimated using the network's knowledge of base station locations and antenna directions.

Other components that may generate data that is useful in determining the point-of-view of the camera assembly 12 may be one or more perspective sensors 30 that assist in determining a direction in which the camera assembly 12 is pointed. For example, the perspective sensors 30 may include one or more of a digital compass (also referred to as a magnetometer), a gyroscope and associated logic for tracking tilt of the electronic device 10, an accelerometer and associated logic for tracking movement of the electronic device 10, an altimeter for tracking a height value relative to sea level, etc. In other embodiments, a GPS location determination may include ascertaining altitude information.

The information from the position data receiver 29 and/or perspective sensor(s) may be used to determine a location of the electronic device 10 and a direction in which the camera assembly 12 is pointed. The direction information may include a compass direction (e.g., north, east, west and south, and any direction between these four references) and an elevation (e.g., a positive or negative angle valve with respect to horizontal). Therefore, using a combination of the location information, the direction information and, if desired, the altitude information, the point of the view of the camera assembly 12 may be ascertained.

The electronic device 10 may further include an event video sharing function 32 that, among other tasks, may be configured to determine the point-of-view and the location of the camera assembly 12. Additional details and operation of the event video sharing function 32 will be described in greater detail below. The event video sharing function 32 may be embodied as executable code that is resident in and executed by the electronic device 10. In one embodiment, the event video sharing function 32 may be a program stored on a computer or machine readable medium. The event video sharing function 32 may be a stand-alone software application or form a part of a software application that carries out additional tasks related to the electronic device 10.

The I/O interface 98 may be in the form of typical mobile telephone I/O interface, such as a multi-element connector at the base of the electronic device 10 or other suitable I/O interface. As is typical, the I/O interface 98 may be used to couple the electronic device 10 to a battery charger to charge a power supply unit (PSU) 100 within the mobile terminal 12.

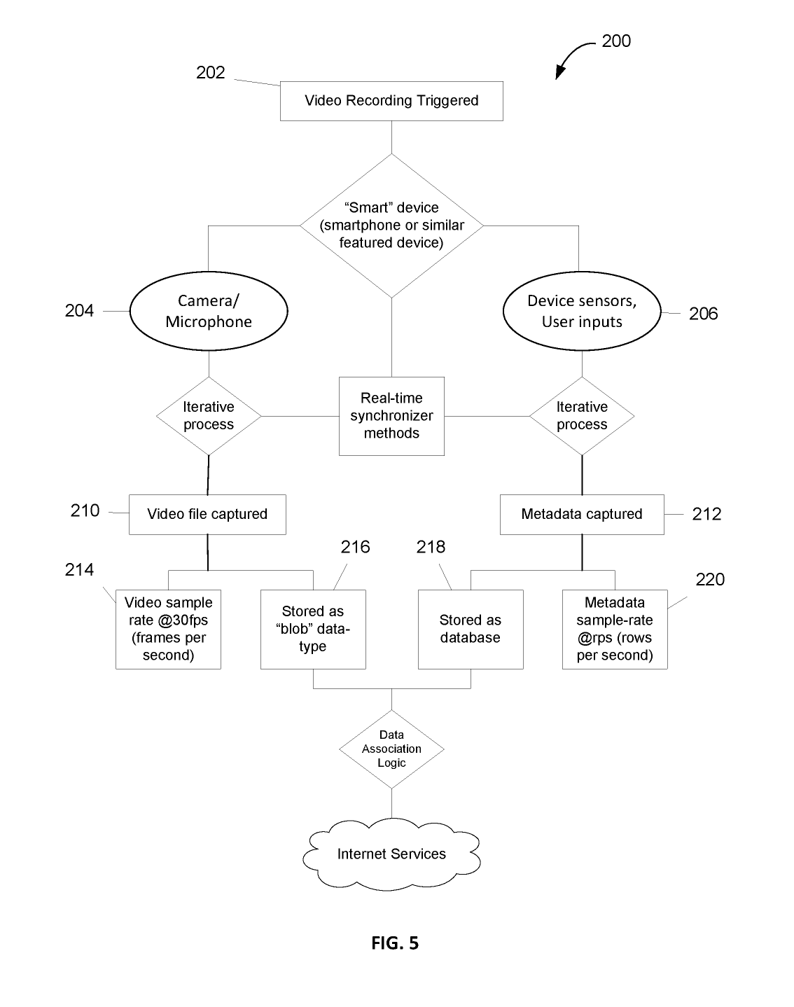

With additional reference to FIG. 4, the event video sharing function 32 may use the point-of-view information as part of a way to share videos between two or more electronic devices 10. In one embodiment, the sharing of photos based on point-of-view information may be coordinated by an event video support function 34 that is hosted by a server 36. As described in greater detail below, the video sharing support function 34 may include an image or video database 38.

The server 36 may be part of a communications network 40 in which the electronic devices 10 are configured to operate. For instance, the server 36 may manage calls placed by and destined to the electronic devices 10, transmit data to the electronic devices 10 and carry out other support functions. In other embodiments, the server 36 may be outside the domain of the communications network 40, but may accessible by the electronic devices 10 via the communications network 36. Also, each electronic device 10 may be serviced by a separate network. The communications network 40 may include communications towers, access points, base stations or any other transmission medium for supporting wireless communications between the communications network 40 and the electronic devices 10. The network 40 may support the communications activity of multiple electronic devices 10 and other types of end user devices. As will be appreciated, the server 36 may be configured as a typical computer system used to carry out server functions and may include a processor configured to execute software containing logical instructions that embody the functions of the event video sharing support function 34 and a memory to store such software.

Additional details and operation of the event video sharing support function 34 will be described in greater detail below. The event video support function 34 may be embodied as executable code that is resident in and executed by the server 36. In one embodiment, the event video support function 34 may be a program stored on a computer or machine readable medium. The event video support function 34 may be a stand-alone software application or form a part of a software application that carries out additional tasks related to the server 36.

It will be apparent to a person having ordinary skill in the art of computer programming, and specifically in application programming for camera, mobile telephones and/or other electronic devices, how to program the electronic device 10 to operate and carry out logical functions associated with the event video sharing function 32 and how to program the server 36 to operate and carry out logical functions associated with the event video sharing support function 34. Accordingly, details as to specific programming code have been left out for the sake of brevity. Also, while the functions 32 and 34 may be executed by respective processing devices in accordance with an embodiment, such functionality could also be carried out via dedicated hardware or firmware, or some combination of hardware, firmware and/or software.

Also, through the following description, exemplary techniques for disparate video correlation, production and playback are described. It will be appreciated that through the description of the exemplary techniques, a description of steps that may be carried out in part by executing software is described. The described steps are the foundation from which a programmer of ordinary skill in the art may write code to implement the described functionality. As such, a computer program listing is omitted for the sake of brevity. However, the described steps may be considered an algorithm that the corresponding devices are configured to carry out.

The event video sharing function 32 (also referred to as a “mobile application”) resides on the user's mobile phone or other electronic device 10. The electronic device may utilize any operating system (e.g., iOS, Android, Windows, etc.). The event video sharing function 32 is operative to capture video and “meta-data” that facilitates processing the event and camera information at the server 36 for the automated production of a single playback video based on a plurality of user's captured videos.

The following is a brief overview of features that make up the event video sharing function 32, which may be summarized as video with time-synchronized picture, system, environmental, and user generated meta data, collection and storage.

Establish Time Sync Offset: Compare device hardware clock with clock synchronization source (e.g. a NTP server, a device peer “master” clock, global positioning satellite signals or pulses, event detection, an atomic clock, sound sources, etc.) during the recording process of each of the videos. The offsets between the electronic device 10 system clock and synchronization source are logged during recording to find the best time resolution and enable this time-synchronization process to occur asynchronously during recording. This ensures other electronic devices 10 executing the event video sharing function 32 that also checked the synchronization source will be within a few microseconds of clock time-drift accuracy. Post-processing on the video file in by the event video sharing function 32 is done after video file is recorded. This enables a trim function on the beginning and end of the video file to the nearest second of synchronized time, which facilitates video alignment (e.g., HTTP Live Streaming (HLS) chunk alignment) on the central server 36 with disparate videos (e.g., videos from different users).

Data Structure: Common categories of data to be captured by the event video sharing function 32, which are normally not captured during a video recording on any device include: recording device accelerometer XYZ axis, gyroscopic XYZ rotational motion, magnetic compass vector, GPS latitude, longitude, altitude, temperature, ambient light, sound track decibels, device camera selection (front-rear camera), focus status, aperture, focal-length, heart-rate (measuring excitement), radio interface signal strength (WiFi signal, Cellular signal, Bluetooth signal, etc.), and custom meta-data events. These will be saved as row updates to a portable tabular data structure (CoreData, JSON, SQLLite).

Time-based Meta Data Capture: All of the data captured is unique in that it is synchronized with the video being taken through a process of locking onto a common time source and recording an initial synchronization between the video being taken and the information being recorded. This information is coming from a variety of sources listed below but are all synchronized so that each data point can be affiliated with a particular time element of the video captured.

Linear Environmental Meta-data Recording: This describes the process by which data inputs are sampled for value status in-sync with the video recording process. When the device camera status changes to “record-mode”, the event video sharing function 32 launches a parallel system thread. This thread is a loop that runs until the device video camera status changes to “stop-mode” or not recording video. This loop is a highly-accurate timer circuit with error-correction methods that are used to synchronize itself to the device recording process. Since video itself is a series of still pictures played back in sequence very quickly (a sample of real-time), the event video sharing function 32 also samples the device and user inputs in this very method. For example, if the video records at 30 frames-per-second, the application may be set to sample 5 “rows-per-second” to a table in memory 44 on the device 10 of device's input statuses. This sampling of changing device sensor data facilitates telling a story over time with the data by associating it to the video and audio assets. If this parseable type of structure exists during the creation process, formulating logical assembly of disparate videos instantaneously becomes possible.

GPS & Vector:

GPS for location: GPS plays a key role in filtering the network of users both while at events/locations with the event video sharing function 32 and for filtering data archived on the central server 36. During live events, GPS and local area networks will aid in determining the users and videos that can be synchronized through the system 1. Archive video footage may be associated by GPS location to aid in determining disparate video continuity.

GPS-based local peer network discovery: GPS-based local peer network discovery may be used for several purposes in the event video sharing function 32 to initiate sessions between user devices and transmit relevant data between users in a “real-time” manner.

Gyroscope & Accelerometer—detecting types of camera movement: Measuring the values over time of the on-board device sensors will provide insights into the types of camera movement that could be categorized. For example, if the accelerometer's values indicate the device 10 is angled towards the ground, this could indicate a higher vantage point towards the subject of interest and vice-versa. Types of motion that may occur during video filming can be detected via this method: camera panning, tilting, trucking, dollying, walking, running, jumping, shaking, stopping, starting, steady, dropping, flying, etc.

Compass—for camera direction: Sampling the compass values overtime provides the ability to infer a real-time vector of the camera angle on a map. If information is known about the physical location (floor plans, drawings, etc.), subject point, and subject distance from device, conventional methods (e.g., Pythagorean methods) may be used to determine camera position/viewpoint. In other words, while users are recording video, we can determine in real-time where people are in a room without relying on GPS lock.

Real-time camera performance feedback: This is a method for evaluating a buffered sample of the device sensor data to determine the type of camera motion and receiving a recommendation from the server 36 to aid in the video production process (Automated live video director).

Local P2P Device Mesh Networking for Disparate Device Types: This describes the method for implementing peer-to-peer local networking between devices with the event video sharing function 32 running on them. These P2P connections are generally necessary for devices that do not have cellular or WiFi connections to transmit and receive data in real-time with the central server 36. For example, devices that have cellular data connections may become the “Master” in a time synchronization method and devices that do not have an internet connection, become “Slaves” in the time synchronization methods. The event video sharing function 32 is generally provided the ability to auto-negotiate these peer network connections during events to transmit data between the peer network connections.

User Interface: The user interface is designed to control the electronic device 10 as well as the functionality of the event video sharing function 32.

In one embodiment, with the event video sharing function operating in the foreground or the background, a change in position from a first orientation to a second orientation (e.g., rotating the electronic device 10 from portrait mode to landscape mode or from landscape mode to portrait mode) will initiate the camera opening and recording still or video images.

The display 22 provides a camera preview window, which provides a visual feedback 200 of the quality of the acquired images or video. In one embodiment, the user interface provides a visual feedback 200 and/or an audio feedback from the speaker 92 the moment when quality parameters are deemed to fall below one or more threshold values. For example, the image or video is shaking too much, the acquired image or video is too light or too dark.

In one embodiment, a push notification may be sent to one or more users registered with the server 36 that are in vicinity of electronic device 10 when the electronic device is acquiring images and/or videos, for example. This feature may be a default feature or configurable by the user in user settings or options, for example. In a video streaming version, the notification provides information to the user receiving the notification to allow user to become part of the bigger picture. For example, by taking video in the same area or be able to watch another person's view by attaching to their data in streaming format. One use case may be at a concert or sporting activity, where a user is able to view the stream of a videographer or camera placed in a position that is desirable for viewing position (e.g. a front row) another user can view the desired video stream originating from this desirable viewing position (e.g., a user far away from the activity, may obtain the video stream of a user or device in the more favorable viewing position.

The user interface of the event video sharing function 32 also provides the user with the ability to log information about the video. For example, the user may enter a title, one or more categories, a description of the video, comments for video playback display or any other desired information.

The user interface of the event video sharing function 32 also may include a chat feature—from the application the user can chat with: another individual; a specific group of people; the public, for example. As discussed in more detail below, the user may also select where to share the video being taken: Facebook, YouTube, google+, server 36, Dropbox, etc.

In another exemplary use case, the display 22 may include a geographical map (e.g., a global map, a country map, a city map, or any other suitable type of map that that is instructive to illustrate to the user where users of the event video sharing function are being taken or have been taken in the past and show the density of people recording in that same vicinity/time frame, for example. The display 22 may also utilize local video mapping to show devices in the immediate vicinity of the current video being taken.

In one embodiment, the map may show the view angle and direction of each camera as the video is being played and/or acquired. The map may also show the positions of the cameras taking video in the same vicinity at the same time.

The user interface may include an overlay button that can be used in different situations allowing user to associate “smart tags” with events in the video. this feature has a multi-purpose function and may be represented. Such “smart hash tags” may be dependent on the event being recorded. For example, a wedding—when the bride and groom dance, kiss, etc.; a sports event—when there is a touch down, fumble, interception etc.; news event—for weather, “good story”, fire, car accident, etc. A person of ordinary skill in the art will readily appreciate that any tag may be used in accordance with aspects of the present invention. In addition, the “smart tags” may be user-defined and/or created by the user.

Another aspect of the invention relates to the implementation of videographer tags, which provide the ability of a user to tag sections of a video with notations that enhance the automatic production of a single video production from a plurality of different videos. Exemplary videographer tags, include, for example: instant replay, crowd scene, still shot, first person point of view shot, wide shot, close up, and angle.

The user interface also enables a plurality of playback modes (or views). For example, a local playback view may be provided, which facilitates a user reviewing only video obtained on their electronic device. In addition, a server playback view also be provided, which enables a user to view videos stored or otherwise associated with server 36. In the server playback view, a user may review videos from a desired location and time of their choice.

The user interface may also enable camera switching. Camera switching is the ability to change video acquisition from—switch recording from the front camera to do the selfie camera for a quick “fan reaction” shot or news commentary, then go back to the front camera, for example.

The user interface may start with a simple point and click, but also has: User Buttons for Social Media Interaction; User Buttons for Event Incident Identification; and the ability to press a UI overlaid button during event video recording to mark an event. For example “Touch Down” at a football game, marking a “Tee-Off” at a golf event, etc. These events may also be associated with a master timestamp. The user interface also includes Automated Camera Director Instructions, which provide real-time instructions and performance feedback from the central-server 36 or peer device overlaid on the camera viewfinder to direct the camera operator towards predetermined camera angles of the event.

Video Record/Upload Heuristics: User text tags/updates, still image frames of video and the video source file may be captured and transmitted to the central-server 36 during and/or at various stages around event recording. The still frames and text may be used for social media elements to advertise the event and may be uploaded to the central-server 56 immediately (e.g., in real-time). The event video sharing function 32 on the video device may wait to upload the source video file to be associated to the still-frames and user text until user-defined parameters are met.

Video Capture Features: The recording of videos may be synchronized to a synchronization source (e.g. a NTP server, a device peer “master” clock, global positioning satellite signals or pulses, event detection, an atomic clock, sound sources, etc.), which allows all disparate videos to be aligned down to the desired timing interval (e.g., seconds, one second, tenth of second, hundredth of a second, millisecond, etc.). NTP servers are particularly useful in this environment as they provide a networking protocol for clock synchronization between computer systems over packet-switched, variable-latency data networks. As set forth above, video can also be synchronized to other sources (e.g. a device peer “master” clock, global positioning satellite signals or pulses, event detection, an atomic clock, sound sources, etc.).

In one embodiment, video file segments may be evaluated for quality in real-time and results recorded along with other live parameters. An indication of quality may be provided to the user on the display 22 or otherwise made available to the user. The video segments and overall video may be monitored for quality. In one embodiment, video file segments determined to be bad quality via reaching a threshold of metadata events can skip being uploaded, the application server or servers 36 will fill the gaps with other content or source video from other devices. Exemplary actions that may be indicative of poor quality include, cameras shaking; portrait mode; out of focus; dark images; color balance shifts.

The time synchronization of videos may occur at any time in the recording and/or processing phases. For example, the time synchronization may be done before, during and/or after the video is recorded and/or streamed to the server 36.

System Meta-data Collected/stored During Recording: Any information available from the device and/or video camera may be recorded and stored in metadata. For example, the following data may be stored as metadata or stored in the video file as data: gyroscope-x axis values; gyroscope-y axis values; gyroscope-z axis values; accelerometer-x axis values; accelerometer-y axis values; accelerometer-z axis values; compass vector; gps-latitude; gps-longitude; nearby WiFi Service Set Identifiers (SSIDs), nearby Bluetooth device identifiers; signal strengths for cellular, WiFi, Bluetooth, and other radio measurable beacons; peer device distances; ambient brightness; altimeter; NTP offset; network time; auto-focus status; focal setting; zooming status; zoom setting; camera setting; ambient audible loudness; camera flash; x, y coordinates of facial detection; scene movement detection; peripheral devices provide additional data such as, heart-rate; running cadence, and more. This data may be stored with every frame of acquired video, may be stored based on a user-defined amount of time; or may be stored at a predetermined interval based on the event being recorded, for example.

User Metadata Collected/stored During Recording: When a user presses one or more buttons on the user interface, hash tags and descriptive input may be entered by the user in the metadata for storage during recording. In one embodiment, metadata is sampled once per frame for the set frames per second, which may be measured in rows per second.

The metadata stored may be dependent on the camera recording the event. For example, when using the front-facing camera the vector numbers from the compass is inverted to adjust the display field of view on the map. Metadata may be exported to any desired programming language. For example, in one embodiment, the metadata may be exported into a JavaScript Object Notation (JSON) segment files that correspond to video file segments similar to HTTP Live Streaming (also known as HLS protocol) for use in Apple's QuickTime, Safari, OS X, and iOS software, for example.

In one embodiment, the metadata may be used so that the user has the ability to see how many other devices (or people) are downloading (or viewing) a particular video stream. In another embodiment, the user may also view thumbnail presentation of other video streams stored by the server 36.

Central Infrastructure: The system and method rely on the event video sharing function 32, which relies on a central infrastructure (e.g., one or more servers 36) where video from a plurality of users attending an event is collected, parsed, and processed with the resulting production stored for quick access via social media venues.

Video Processing: The video processing that takes place on the server 36 is unique in that disparate videos are brought together using information that facilitates automatic generation of a full production that provides a completely unique view of a common event. For example, one video stream contains video clips from each of the users enabled through the event video sharing function 32 and the server 36 to share their videos with other users. One way to describe this process is Time-Spliced Video Data Correlated with Meta-Data and stored in a database 38 to enable automated stream concatenation and production. This concept is illustrated as follows: a source video file is received by the central server 36. The central server also receives the device 10 environment meta-data file created during recording and associates the two files on the central server database. The source video file is used and re-encoded to create additional copies of the file in various file-formats. One of these formats is Apple Inc.'s HLS protocol (HTTP Live Streaming). This format enables video to be played back via a series of video “chunks” or “files” in a textual playlist format. Once the source file is re-encoded in this format, there exists a folder of video files and a playlist file that contains meta data about the file, required for the video decoder to accurately play the file. This playlist contains instructions on how to playback the video file chunks in the same order as the source video. The central server parses this document for the information it needs and loads those values into an online database table. These values are associated to all of the other device/event data available.

In one embodiment, each new video downloaded to the server 36 has an associated “metadata” file that provides an exact time, which could be any desired timing interval when the video begins. This precise timing allows disparate (e.g., from different sources) videos to be spliced together with extreme accuracy.

The video streams may be pre-processed to be able to combine disparate streams there are a number of processing functions that will take place when the new video arrives at the server 36. For example, a new video is processed into one to x second segments. With x being any desired number and may depend on the length of the video or the number of video sources associated with an event. Each segment is evaluated on usability based on a function that takes variable inputs from the metadata and compares them against a specific algorithm to determine usability. example algorithms. The usability algorithm performs several functions: ensure that video taken is in focus; stream association timing—to be a part of a production there must be one or more videos from other sources that are running at the same time or in correlation (front or back of video sequence); stream association location—to be a part of a production there must be on or more videos in the same vicinity; stream association direction—to be a part of a production there must be on or more videos must be pointed in a common direction; do not use video taken when the camera is being shaken; do not use video taken when panning too quickly; and do not use video taken when camera is pointed straight up in the air or straight down to earth. A person of ordinary skill in the art will appreciate that the above list is not exhaustive, but illustrate of some factors that may impact the desirability of using the downloaded in the environment of the event sharing support function 34.

Although the process described above calls for the processing of video data on the server 36, a person of ordinary skill in the art will readily appreciate that video processing may occur on the electronic device 10, on the server 36 or partially on the electronic device 10 and the server 36.

Custom Edits: In accordance with one embodiment, the videographer tags specific features that may be implemented, like a replay of the last two seconds from a different video source, for example.

Video Stream Concatenation: This is another unique process, which may be described as: Event Based Automated Algorithmic-Based Video Edit Decision List Templates. Stream concatenation denotes where logged data-events are queried and used to trigger decision outcomes when comparing two or more video assets to be used at the current position in the HLS playlist. The rules on the way decisions are made change, depending on category of video playlist being generated. These rules may be enforced over hierarchal templates or any other desired manner. The template of algorithms may decide which disparate camera shots pass a series of tests in that template. These tests check for things that would help ensure choosing the best video file outcome for the given query parameters. The algorithm templates for the tests may change over the length of a video's output process. The start of a video sequence will generally have different concerns for matching content parameters than the middle and end of the sequence. Eventually, one camera shot or video file must be chosen for the playlist link in the current position. If there isn't any more content fitting the parameters, the playlist is closed and the resulting video sequence is played for the user. An example of the questions that a stack of tests will aim to answer: is there more than one video at this point in time and location and search scope? If so, which one has the longest point in time of steady, in-focus video? Is this a wide-shot? If so, we are looking to use a wide shot for establishing location at this point in the story. Is there a close up shot? If so, that will become shot after wide shot. If not, what's the next best shot?

This entire process described above yields a single video presentation from multi-video sourced automated production. This describes the process by which a user searches, discovers, or links to a query about a video event that generates a new video production, based on the online resources available (databases, video files, etc.).

The video stream concatenation occurs once the video streams have been segmented and tagged, the event video sharing support function will automatically pull, according to a random timing feature, different segments and paste them together into one continuous clip. The video is then concatenated into one or more formats that are accessible from multiple sources (desktop, mobile device, ipad etc.) for delivery to other devices.

The use of the term “single” is indicative of video data available at the time of generation of the production. When additional video data is received over a period of time after generation of the single video presentation and the additional video is processed upon receiving an additional request for a video presentation, another concatenated video presentation or stream may be generated, which may or may not include at least a portion of the earlier video. That is, the another concatenated video presentation or stream may be different from the original concatenated video presentation.

In one embodiment, artificial intelligence or video object tracking may be used to select streams according to a particular object or pattern appearing in the picture (like following a basketball in a basketball game), for example. In another embodiment, the user may select from the video data stored on the server 36 to select their own video to be displayed. In another embodiment, a central authority may provide hashtags or other labels and video data containing such labels may be used to generate the concatenated video presentation.

Video Editing: Since each video stream has metadata associated with each frame, a range of editing capabilities is possible that was not previously possible with disparate video capture. For example, switching between different streams over the same time segment to select the best view; viewing multiple frames of the same scene from different sources perfectly timed; voice or sound detection to switch between different cameras based on input, but is synchronized with the other streams; and searchable events that correspond to when they happened at the moment during recording.

Social Media: Hash tags may be used to identify, locate and share common videos and “productions” that were generated using the event video sharing support function 34. The event video sharing support function 36 may include an interface to upload or publish to Facebook, Twitter, Google+ or hard drives/storage spaces like Dropbox, Sky Drive, and YouTube, for example. The event video sharing support function 36 may support video “push” notifications to alert nearby users that someone is taking a video using the event video sharing function 32 that they can join in on. In another embodiment, a “map” may be displayed on display 22 that identifies locations where videos acquired using the event video sharing function 32 have been recorded so a user can quickly find videos by time and place. In another embodiment, “push” notifications may be used to alert a user that a burst of videos are currently being taken or have recently been taking using the event video sharing function 32. Such a notification may signify an important event currently occurring somewhere in the world and allow users to stream video acquired from other users but stored on the server 36, for example.

Website Functionality: the server or servers 36 provide the ability to view auto-edited video streams from disparate devices with differing angles from a variety of videographers. In one embodiment, the server 36 processes the acquired video streams into a single video stream. In another embodiment, the server 36 enables users the ability to hand-select different views on the fly. In another embodiment, the event video sharing function 32 may present streams available at the exact moment (down to the second) where the video is being recorded. The event video sharing function 32 may also be configured to display a map showing the location of other cameras in the area; a map showing the angle of the various views; and/or a map showing the quality of each of the cameras on the map.

In another exemplary use case, the event video sharing support function 34 and the event video sharing function 32 may be used to break news to users of event video sharing function 32. For example, a push notification may be sent to one or more users registered with the server 36 when a substantial increase of independent video streams are being taken from a particular geographic location. Such an increase may be attributable to a news event or other significant activity. A user may set one or more notifications such that when the number of video streams originating from a particular geographic location is a above a prescribed amount (e.g., 50% or 100% increase), the server 36 transmits a push notification to the electronic device 10. The user may select one or more video streams downloaded to the server 36 or the user may select the server to generate a single concatenated video stream in which to view.

Limit Access at Certain Locations and/or Times: In one embodiment, it may be desirable to limit streaming of video data from the server 36. Metadata (e.g., GPS coordinates, camera angle, and other variables) may be used to determine what is being recorded and keep the recordings from being to accessible users not at the current venue during the time of the event. Certain venues may be “boxed out” during certain times to deter piracy. For example, during a professional sporting event, an electronic device 10 may be prevented from streaming the event to persons not at the particular sporting venue during the time of the sporting event. In one embodiment, once the sporting event has completed, access to the video data may be provided to users not in attendance at the sporting event, for example.

Referring to FIG. 5, an exemplary method in accordance with aspects of the invention are illustrated. FIG. 5 illustrates the functionality of the event video sharing function 32. At block 202, a video recording is triggered. The video recording may be triggered by the user pressing a button or changing the orientation from a first mode to a second mode as discussed above. At block 204, camera and microphone data are processed in one data path and at block 206, device sensors and user-inputs are processed along a separate data path. At block 208, the data is synchronized as discussed above and stored in a video capture file at block 210 and metadata file 212. The video capture file may be stored as video having a conventional sampling rate of 30 frames per second, in block 214 and is also stored as a binary large object (BLOB) data type, at block 216. The metadata of block 212 is stored as a database, at block 218, and the metadata sample rate is four (4) rows per second, as illustrated at block 220. At block 222, the data association logic combines the video and metadata and transmits the synchronized video to the server 36 for storage via the Internet Services 224.

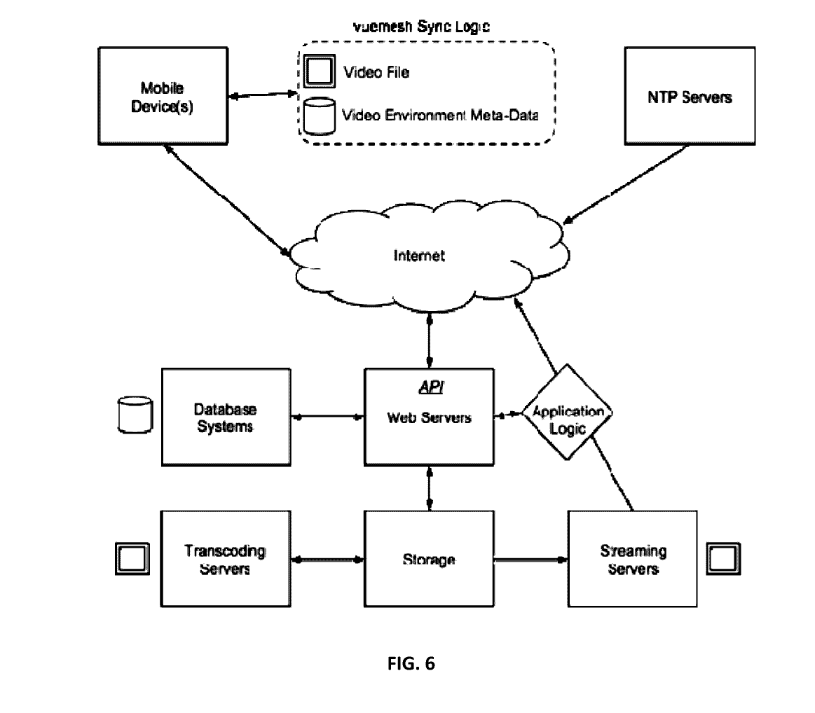

FIG. 6 illustrates an exemplary embodiment of video and metadata synchronization in accordance with aspects of the present invention. As illustrated in FIG. 6, mobile devices acquire video files and metadata associated with the video files. The server 36 receives the data along corresponding data from one or more synchronization sources (e.g. a NTP server, a device peer “master” clock, global positioning satellite signals or pulses, event detection, an atomic clock, sound sources, etc.). The resulting data is synchronized and stored using a desired transcoding method.

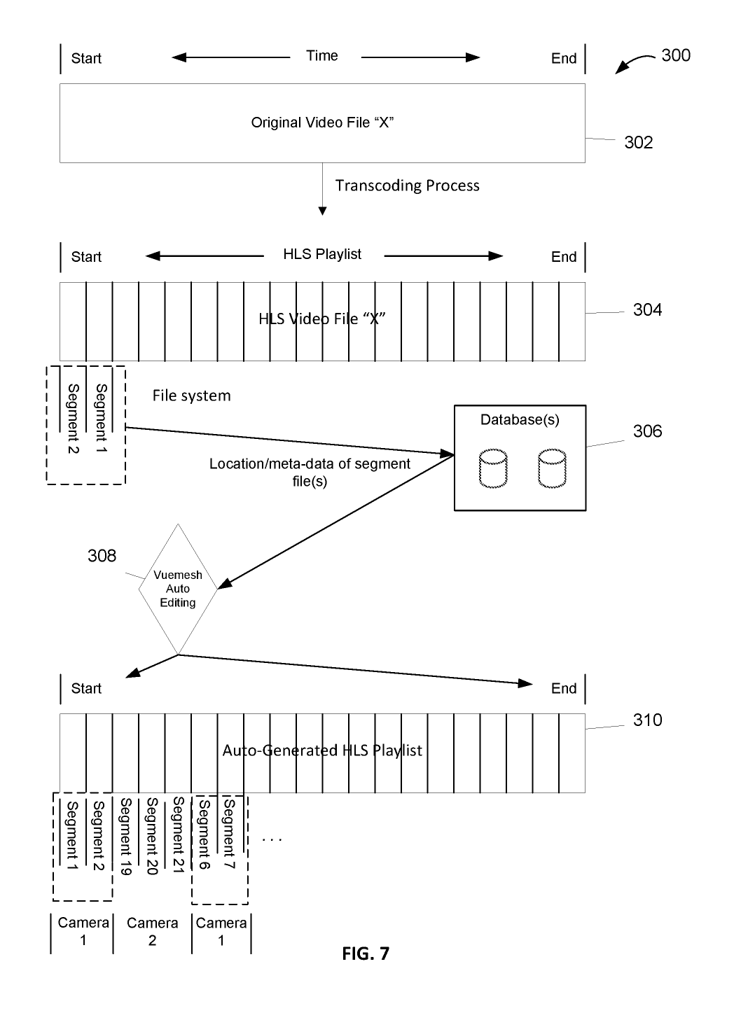

FIG. 7 is an illustration of an exemplary method 300 for producing a single concatenated video stream from a plurality of devices. At block 302, an original video file is received. At block 304, the transcoding process breaks the video file into a HLS playlist comprising a number of segments. At block 306, the segments are stored on one or more servers 36. At block 308, the server automatically edits the plurality of disparate video streams to generate a single video stream that is made up of video streams from a plurality of electronic devices, which is illustrated at block 310.

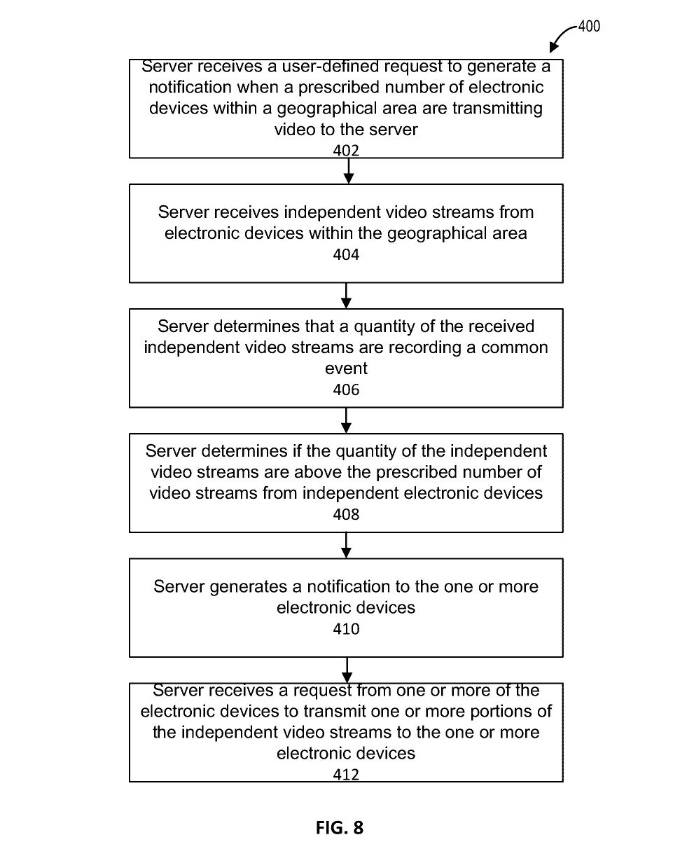

Referring to FIG. 8, a computer-implemented method 400 for selecting a video stream display captured by a plurality of disparate electronic devices in accordance with aspects of the present invention is illustrated. At block 402, the server receives a user-defined request to generate a notification when a prescribed number of electronic devices within a geographical area are transmitting video to the server. At block 404, the server receives independent video streams from electronic devices within the geographical area. At block 406 the server determines that a quantity of the received independent video streams are recording a common event. At block 408, the server determines if the quantity of the independent video streams are above the prescribed number of video streams from independent electronic devices. At block 410, the server generates a notification to the one or more electronic devices. At block 412, the server receives a request from one or more of the electronic devices to transmit one or more portions of the independent video streams to the one or more electronic devices.

In another embodiment, the received independent video streams are processed based on a time synchronization offset and the acquisition parameters to generate a single concatenated video stream and transmitting the single concatenated video stream to one or more of the electronic devices.

Computer program elements of the invention may be embodied in hardware and/or in software (including firmware, resident software, micro-code, etc.). the invention may take the form of a computer program product, which can be embodied by a computer-usable or computer-readable storage medium having computer-usable or computer-readable program instructions, “code” or a “computer program” embodied in the medium for use by or in connection with the instruction execution system. in the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. A computer-implemented method for producing a single concatenated video stream, the method comprising:
receiving video data at a server from a plurality of electronic devices within a prescribed geographic area, wherein the video data includes image data and acquisition parameters associated with acquisition of each of the video streams, and the video data includes a time synchronization value to index the video data received by each of the plurality of electronic devices; and
processing the received video data based on the synchronization offset and the acquisition parameters to generate a single concatenated video stream from the plurality of electronic devices.

2. The method of claim 1, wherein the acquisition parameters include at least one selected from the group of: stability of the image, accelerometer information, gyroscopic information; magnetic compass vector; GPS coordinates, temperature, ambient light, sound, device camera selection, focus parameters, aperture, focal length, heart-rate of the associated user, radio interference signal strength.

3. The method of claim 2, wherein the acquisition parameters are stored in a database stored in a memory associated with the server.

4. The method of claim 2, wherein each of the acquisition parameters is synchronized with the video based on the time synchronization value.

5. The method of claim 2, wherein the single concatenated video stream is based on an analysis of each of the image acquisition parameters.

6. The method of claim 1, further including receiving an initialization request from an electronic device when recording of an image is initiated.

7. The method of claim 1, wherein the video data is received at the server after the electronic device terminates image acquisition for the video data.

8. The method of claim 1, wherein additional video data is received over a period of time after generation of the single concatenated video stream and the additional video processed upon receiving an additional request for concatenated video stream; and generating another concatenated video stream including at least a portion of the additional video data.

9. The method of claim 8, wherein the single concatenated video stream is different from the another concatenated video stream.

10. An electronic device, comprising:
a camera assembly, wherein the camera assembly is configured to record video images represented on an imaging sensor, the camera assembly further includes imaging optics associated with focusing of the camera assembly;
a position data receiver configured to detect a geographical location of the electronic device;
a memory configured to store the video images and information associated with the imaging optics and the position data receiver, the memory further configured to store an event sharing support function; and
a processor configured to execute the event sharing support function, which causes the electronic device to request a time synchronization value from a remote server upon initiation of the camera assembly, wherein the processor is further configured to store the video images and the information in a synchronized manner based on the time synchronization value; and
a communication interface for transmitting the video images and information to an associated server.

11. A method for displaying a single concatenated video stream generated from a plurality of devices on an electronic device, the method comprising:
transmitting a request to a remote server for a single concatenated video stream generated from a plurality of devices within a prescribed geographical area;
receiving the single concatenated video stream at the electronic device; and
displaying the video stream on a display associated with the electronic device.

12. A computer-implemented method for selecting a video stream display captured by a plurality of disparate electronic devices, the method comprising:
receiving a user-defined request from a server to generate a notification when a prescribed number of electronic devices within a geographical area are transmitting video to the server;
receiving independent video streams at the server from electronic devices within the geographical area;
determining, at the server, that a quantity of the received independent video streams are recording a common event;
determining, at the server, if the quantity of the independent video streams are above the prescribed number of electronic devices;
generating, at the server, a notification to one or more electronic devices;
receiving a request, at the server, from one or more of the electronic devices to transmit one or more portions of the independent video streams to the one or more electronic devices.

13. The method of claim 12, wherein the independent video streams include image data and acquisition parameters associated with acquisition of each of the video streams, and the video data includes a time synchronization value to index the video data received by each of the plurality of electronic devices; and

14. The method of claim 12, processing the received independent video streams based on the time synchronization offset and the acquisition parameters to generate a single concatenated video stream and transmitting the single concatenated video stream to one or more of the electronic devices.

15. The method of claim 14, wherein additional video data is received over a period of time after generation of the single concatenated video stream and the additional video processed upon receiving an additional request for concatenated video stream; and generating another concatenated video stream including at least a portion of the additional video data.

16. The method of claim 15, wherein the single concatenated video stream is different from the another concatenated video stream.
